(19) United States
(12) Patent Application Publication
(10) Pub. No.: US 2010/0227771 A1
(43) Pub. Date: Sep. 9, 2010

(54) METHODS FOR DETECTION OF TARGET ON RESPONSIVE POLYMERIC BIOCHIPS

(75) Inventors: Ahmed Najari, Quebec (CA); Hoang-Anh Ho, Quebec (CA); Mario Leclerc, Quebec (CA)

Correspondence Address: CHOATE, HALL & STEWART LLP, TWO INTERNATIONAL PLACE, BOSTON, MA, 02110, US

(73) Assignee: Universite Laval, Quebec (CA)

(21) Appl. No.: 12/305,197

(22) PCT Filed: May 11, 2007
(86) PCT No.: PCT/CA2007/000857

§ 371 Date: Apr. 28, 2010

Related U.S. Application Data
(60) Provisional application No. 60/799,340, filed on May 11, 2006.

(51) Int. Cl. C40B 30/04; C40B 40/06; C40B 50/14

(52) U.S. Cl. 506/9; 506/16; 506/30

(57) ABSTRACT

Methods and tools (e.g., kits, articles of manufacturing, support and arrays) for the solid-phase detection of a target molecule using a cationic polymer and nucleic acid probe complex is provided herewith. These methods and tools allows for the reagentless, ultrasensitive and specific detection of nucleic acids, proteins and other molecules of interest and are based on a labeled complex made of specific capture probes and a polythiophene derivative.

### FIELD OF THE INVENTION

The present invention relates to the solid-phase detection of a target molecule using a cationic polymer and nucleic acid probe complex. More particularly, the present invention relates to the reagentless, ultrasensitive and specific detection of nucleic acids and proteins. The present invention also relates to methods, assays, kits, articles of manufacturing, support and arrays based on complex immobilized to a solid support.

### BACKGROUND OF THE INVENTION

Simple and ultra sensitive methods are needed for the rapid diagnostic of infections and genetic diseases, as well as for environmental and forensic applications. For this purpose, various optical and electrochemical DNA sensors have been proposed.

Biochips have revolutionized biomedical research since it allows specific analyses to be performed in miniaturized highly parallel formats¹⁻⁵. Biochips are generally fabricated from glass, silicon, gold, or polymeric substrates onto which DNA probes or other bio-molecules have been immobilized (spotted) on a small surface. Target molecules that bind to a specific probe are usually detected through optical or electrical means. However, in most cases, a highly specific and ultrasensitive detection of the targets involves a tagging of the analytes and/or the utilization of sophisticated experimental techniques. For instance, chemical amplification of DNA targets through the polymerase chain reaction⁶ (PCR) is often required but implies complex mixtures and hardware to perform the enzymatic reaction. Moreover, non-specific labeling with various functional groups may even compromise the binding properties of the target.

U.S. Pat. No. 7,083,928 describes the aqueous or electrochemical detection of target/capture probes complexed with a cationic polythiophene derivative. Methods are described for detecting a change in the fluorescent or colorimetric characteristics of the cationic polythiophene derivative upon complexation of the target and capture probe. However, these methods require several steps and are not as sensitive as desired. Furthermore, these methods do not allow detection of several different targets in a single assay.

Patent application No. PCT/CA2006/000322 describes aqueous detection methods relying on the amplification of the intrinsic fluorescence signal of the polythiophene derivative with neighboring fluorophores attached to the probe. However, these detection methods are time consuming and are not easily expanded to the detection of multiple targets at the same time.

Some of these limitations are addressed by using a new generation of responsive biochips demonstrating strong modification of optical or electrical properties upon the specific and efficient binding of a given target.

There thus remain a need to develop rapid, simple and ultrasensitive methods and tools for the detection of nucleic acid and protein targets.

The present invention seeks to meet these needs and other needs.

The present description refers to a number of documents, the content of which is herein incorporated by reference in their entirety.

### SUMMARY OF THE INVENTION

The present invention relates to the solid-phase detection of a target molecule using a cationic polymer and nucleic acid probe complex.

More particularly, the present invention relates to the reagentless, ultrasensitive and specific detection of nucleic acids, proteins, protein complex (DNA or RNA polymerases, etc.) or any other molecules capable of binding to a nucleic acid.

The present invention also relates to methods, assays, kits, articles of manufacturing, support and arrays using a complex made of a cationic polymer and a nucleic acid probe immobilized onto a solid support.

The applicability of the new responsive polymeric arrays and methods are more particularly based on hybrid polythiophene/ss-nucleic acid complexes for the reagentless, ultrasensitive, and specific optical detection of nucleic acid, proteins, protein complex (DNA or RNA polymerases, etc.) or any other molecules capable of binding to a nucleic acid.

Target which may advantageously be detected using methods, assays, kits, articles of manufacturing support and arrays provided herein may be any molecule having an affinity for a specific sequence of nucleic acid. Exemplary embodiments of target includes, without limitation, nucleic acids, proteins, protein complexes, peptides, ions, vitamins, chromophores, coenzymes, amino acids and derivative, antibiotics, synthetic drugs, etc.

The present invention therefore provides in a first aspect thereof, an article of manufacturing comprising at least one labeled single-stranded anionic (negatively charged) nucleic acid capture probe immobilized to the surface of a support and a cationic polythiophene derivative electrostatically bound to the nucleic acid capture probe.

More particularly, the present invention provides an article of manufacturing which may comprise a solid support onto which is attached a complex formed by a labeled single-stranded nucleic acid probe and a polythiophene derivative of formula I

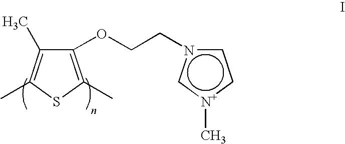

wherein n is an integer ranging from 6 to 100 (or else) and;
wherein the labeled single-stranded nucleic acid probe is covalently attached to a surface of the solid support and the polytiophene derivative is in electrostatic interaction with the labeled single-stranded nucleic acid probe.

The present invention also provides kits comprising the article of manufacturing described herein or vials comprising some or all of its isolated components. The kit may also comprise instructions for making and/or using the same or to carry the detection methods.

The present invention provides in an additional aspect thereof, an array of labeled single-stranded anionic nucleic acid capture probes immobilized to a support, the nucleic acid capture probes being complexed with a cationic polythiophene derivative. The array may thus comprise at least two different nucleic acid capture probes species complexed with the polythiophene derivative and each of the probe species may be attached to a different predetermined section of the support. The arrays may thus be addressable.

More particularly, the present invention provides an array which may comprise a plurality of labeled single-stranded nucleic acid probe species covalently attached to a different predetermined region of a solid support surface and a polytiophene derivative in electrostatic interaction with each of the labeled single-stranded nucleic acid probe species, the polythiophene derivative having formula I

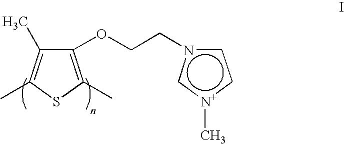

wherein n is an integer ranging from 6 to 100 (or else).

The present invention also provides in an additional aspect thereof, a method of determining the presence of a target in a sample by contacting an article, support, kit or array described herein (having a labeled probe able to bind to the target sought to be detected to which a polythiophene derivative is complexed) and a sample which comprises the target or is suspected of comprising the target.

The present invention also provides in a further aspect thereof, a method of detecting, quantifying, isolating or purifying a target by contacting an article, support, kit or array described herein and a sample which comprises the target or is suspected of comprising the target. Targets may be isolated or purified by elution from the complex using methods known in the art.

More particularly, the present invention provides a method for the detection of a target, the method may comprise for example, contacting a sample comprising the target or susceptible of comprising the target with a complex formed by a labeled single-stranded nucleic acid probe attached to a solid support and a polythiophene derivative of formula I

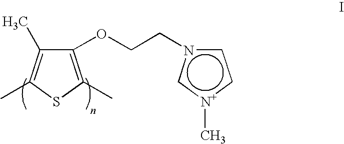

wherein n is an integer ranging from 6 to 100 (or else), and; measuring a signal emitted upon (a conformational change associated with a) specific binding between the single-stranded nucleic acid probe and the target.

The present invention also provides in a further aspect thereof, a method of making (manufacturing) the article, support, kit or array described herein. The method may comprise for example, mixing a single-stranded anionic nucleic acid capture probe comprising an immobilizing (attaching) means and a cationic polythiophene derivative under condition allowing for their electrostatic interaction, and immobilizing the complex onto the surface of a responsive (receptive) solid support.

In yet a further aspect, the present invention provides an assay for determining the presence of a target in a sample or for detecting, quantifying, isolating or purifying the target.

The present invention therefore relates to the detection, quantification, identification of a target in a sample and/or isolation or purification of the target from the sample.

The present invention also relates to a method of diagnosis or prognosis of a disease, disorder or condition in a mammal in need thereof. The method may comprise contacting a sample obtained from a mammal having or suspected of having a disease, disorder or condition and determining the presence or absence of a desired target associated with such a disease, disorder or condition.

More particularly, the present invention provides a method for the diagnosis of a disease, disorder or condition in a mammal, the method may comprise;
a. providing a sample comprising a target or suspected of comprising a target associated with the disease, disorder or condition (obtained from the mammal);
b. contacting the sample with a solid support including a complex formed by a labeled single-stranded nucleic acid probe attached thereto and a polythiophene derivative, wherein the labeled single-stranded nucleic acid probe comprises a nucleic acid sequence capable of specific binding to the target.

Alternatively, the labeled single-stranded nucleic acid probe may comprise a nucleic acid sequence capable of specific binding to a target associated with a normal state.

An exemplary embodiment of a condition or disease which may be readily diagnosed using the present invention may be one associated with a single nucleotide polymorphism (SNP). Therefore detection, quantification, identification, purification or isolation of SNPs or SNP gene products is encompassed by herewith. Several exemplary embodiments of genetic variation associated with disease or conditions may be found in the Online Mendelian Inheritance in Man (OMIM) database. The OMIM database is a catalog of human genes and genetic disorders authored and edited by Dr. Victor A. McKusick and colleagues. Specific non-limiting examples of disease associated with genetic polymorphism may also be found, for example, in PCT applications published under Nos. WO07025085, WO06138696, WO06116867, WO06089185, WO06082570, WO0608267, WO04055196, WO04047767, WO04047623, WO04047514 and WO04042013.

The following also provides a list of disease and conditions which have been associated with genetic polymorphism (e.g., SNPs, mutations). This list is not intended to be exhaustive but only provides examples of the utility of the present invention.
BLADDER CANCER: TP53, DBC1, CDKN2A, ERBB2, FGFR3; etc.
BREAST CANCER: BRCA1, BRCA2 ABCG2 ERBB2 ESR1, etc.
CERVICAL CANCER: TP53, BCL2, TGFB1, PTGS2, RPS12, etc.
COLORECTAL CANCER: MLH1, MSH2, MSH6, PMS2, APC, etc.
ESOPHAGEAL CANCER: VEGF, TP53, EPS8L1, PPARG, ALOX15B, etc.
GASTRIC CANCER: PTGS2, VEGF, WNT5A, TFF1, IGSF4, etc.
HEPATOCELLULAR CANCER: DLC1, TP53, HMGA, CDKN2A, REG3A, etc.
LUNG CANCER: TP53, GSTM1, IGSF4, CDKN2A, PTGS2, etc.
MALIGNANT MELANOMA: CDKN2A, MIA, TNF, LTA, VEGF, .etc.
MULTIPLE ENDOCRINE NEOPLASIA: RET, MEN1, PRKAR1A, HNRPF, SF1, etc.
NEUROFIBROMATOSIS: NF1, NF2, EVI2A, HGS, RAB11FIP4, .etc.
PANCREATIC CANCER: SSTR2, VEGF, SMAD4, PTGS2, F2RL1, etc.
POLYCYSTIC KIDNEY DISEASE: PKD1, PKD2, PKHD1, NOS3, RPL3L, etc.
PROSTATE CANCER: AR, KLK3, CDKN1B, SRD5A2, PTEN, etc.
RETINOBLASTOMA: RB1, E2F1, CDKN2A, ARID4A, E2F4, .etc.
TUBEROUS SCLEROSIS: TSC2, TSC1, YWHAB, RHEB, FRAP1, etc.
ALZHEIMER DISEASE: APP, PSEN1, APOE, MAPT, BACE1, etc.
ASTHMA: IL13, IL9, IL4R, IL4, CYSLTR1, .etc.
DIABETES MELLITUS: WFS1, TCF1, GCK, HNF4A, CAPN10, etc.
HYPERTENSION: AGT, ACE, AGTR1, GNB3, HSD11B2, .etc.
OBESITY: LEP, ADIPOQ, GHRL, LEPR, TNF, etc.

A person skilled in the art will be able to determine which specific genetic variation is associated with disease by searching literature on the subject. A person skilled in the art will also be able to determine that the invention may be used for other diagnostic or prognostic purposes as new discoveries associating genetic polymorphism and disease arise.

Genetic polymorphism has been associated with variation in drug susceptibility within the population. For example, individuals carrying the wild type form or variants forms of CYP12C9 or VKORC1 respond differently to Acenocoumarol and Coumadin. Atomoxetine and irinotecan susceptibility also varies between individuals carrying the wild type of variant form of CYP2D6 and UGT1A1 respectively.

The present invention may thus be useful in the pharmacogenomic field where detection of a gene or a plurality of genes or gene products associated with a resistance or susceptibility to a drug will help in determining the proper therapy for the individual.

The present invention further provides for improved clinical diagnostics of infections in a mammal.

The present invention may thus be used for detecting or quantifying a pathogen or microorganism in a sample originating from the mammal. The present invention may also be used for determining the identity of a pathogen or microorganism in a sample.

The present invention further provides for improved medico-legal (forensic) diagnostics, more specifically the filiation of people and animals, “forensic” tools and other genetic testing tools.

The present invention also provides for environmental and industrial screening, more specifically for the detection of genetically modified organisms, the detection of pathogenic agents, alimentary traceability, the identification of organisms of industrial interest (e.g., alimentary, pharmaceutical or chemical fermentation and soil decontamination).

The present invention further relates to the use of a polythiophene derivative or a complex made of a nucleic acid capture probe and polythiophene derivative described herein in the making of an article, support, kit or array.

The present invention additionally relates to the use of an article, support, kit or array described herein for detecting the presence of a desired target, for quantifying a desired target or for the diagnosis or prognosis of a disease, disorder or condition in a mammal in need thereof.

Further scope and applicability will become apparent from the detailed description given hereinafter. It should be understood, however, that this detailed description, while providing exemplary embodiments of the invention, is given by way of example only, since various changes and modifications will become apparent to those skilled in the art.

The present invention also relates to the isolation of the target once detected using the method described herein.

### BRIEF DESCRIPTION OF THE DRAWINGS

In the appended drawings:

FIG. 1 provides a schematic description of recognition and discrimination of target ss-DNA by duplex aggregates onto glass slides. Visualization of signal amplification detection mechanism based on the conformational change of cationic polythiophene and energy transfer;

FIG. 2 provides AFM images of adsorption of duplexes onto glass surface. The duplexes (Oligodeoxyribonucleotide capture probes+cationic water-soluble polythiophene) were deposited on functionalized glass surface (γ-APS-CDI). (a) 10 μm, (b) 1 μm.

FIG. 3 provides an image of fluorometric detection of hybridization on arrays; (a) λ(408-570 nm) and (b) λ(408-530 nm) where (a.1) and (b.1) correspond to 1×10⁻⁶ M concentration on perfect complementary target; (a.2) and (b.2) correspond to 1×10⁻⁸ M, (a.3) and (b.3) to 1×10⁻¹⁰ M; (a.4) and (b.4) correspond to 1×10⁻¹² M; (a.5) and (b.5) correspond to 1×10⁻¹⁴ M; (a.6) and (b.6) to 1×10⁻¹⁵ M; (a.7) and (b.7) correspond to 1×10⁻⁸ M concentration on target with one mismatch, (a.8) and (b.8) correspond to 1×10⁻¹⁰ M, (a.9) and (b.9) to 1×10⁻¹² M; (a.10) and (b.10) correspond to 1×10⁻¹⁴ M; (a.11) and (b.11) correspond to 1×10⁻¹⁵ M and (a.12) correspond to NaCl (0.1M) solution;

FIG. 4 is a graph illustrating the results of FIG. 3, where the fluorescence intensity is measured at 570 nm with excitation at 408 nm, as a function of the target ss-DNA concentration; black dots (perfect complementary target) and empty square (one mismatch);

FIG. 5 is a graph illustrating the fluorescence intensity, measured at 570 nm with excitation at 408 nm, as a function of the number of copies of target ss-DNA; black dots (perfect complementary target), empty square (one mismatch) and star (Duplex/Hybridization solution only (NaCl 0.1M));

FIG. 6 represent the fluorescence intensity of the detection of different targets where (a) is for the presence of water with a P₅ (5′-NH₂—C₆-GGT GGT GGT TGT GGT-Cy3-3′)/polythiophene probe, (b) water with a P₃ (5′-NH₂—C₆-GGT TGG TGT GGT TGG-Cy3-3′)/polythiophene probe, (c) for a 2.45×10⁻⁵ M solution of BSA with a P₅ (5′-NH₂—C₆-GGT GGT GGT TGT GGT-Cy3-3′)/polythiophene probe is (d) for a 2.45×10⁻⁵ M solution of BSA with a P₃ (5′-NH₂—C₆-GGT TGG TGT GGT TGG-Cy3-3′)/polythiophene probe (e) for a 2.45×10⁻⁵ M solution of thrombin with a P₅ (5′-NH₂—C₆-GGT GGT GGT TGT GGT-Cy3-3′)/polythiophene probe and (f) for a 2.45×10⁻⁵ M solution of thrombin with a P₃ (5′-NH₂—C₆-GGT TGG TGT GGT TGG-Cy3-3′)/polythiophene probe.

FIG. 7 is a graph illustrating the solid state fluorescence measurements of protein detection, where (a) is human α-thrombin (b) is BSA and (c) is IgE at λ(408-570 nm).

FIG. 8 represents the fluorescence intensity of the detection of one target, corresponding to an oligonucleotide DNA sequence (3′-GTA CTA ACT TGG TAG GTG GT-5′) to a perfect match of the Candida albicans probe, by using different capture probes sequences in duplex with the cationic polythiophene transducer. Two concentrations (10⁻⁸M) and (10⁻⁶M), were used. Probe 1 (5′-NH₂—C₆-GGT TGG TGT GGT TGG-Cy3-3′), corresponds to an aptamer sequence which is specific to the Human α-Thrombin protein. Probe 2 (5′-NH₂—C₆-CCG GTG AAT ATC TGG-Cy3-3′), corresponds to the sequence which is using for the detection of the Tyrosinemia type I IVS12+5. Probe 3 (5′-NH₂—C₆-TAG TCG GCG TTC TCA ACA TT-Cy3-3′) was designed to hybridize specifically with human Y chromosome. Probe 4 (5′-NH₂—C₆-CAT GAT TGA ACC ATC CAC CA-Cy3-3′), corresponds to a conserved region of the Candida albicans

### DETAILED DESCRIPTION

The present invention relates to the solid-phase detection of target molecules using a cationic polymer and nucleic acid probe complex.

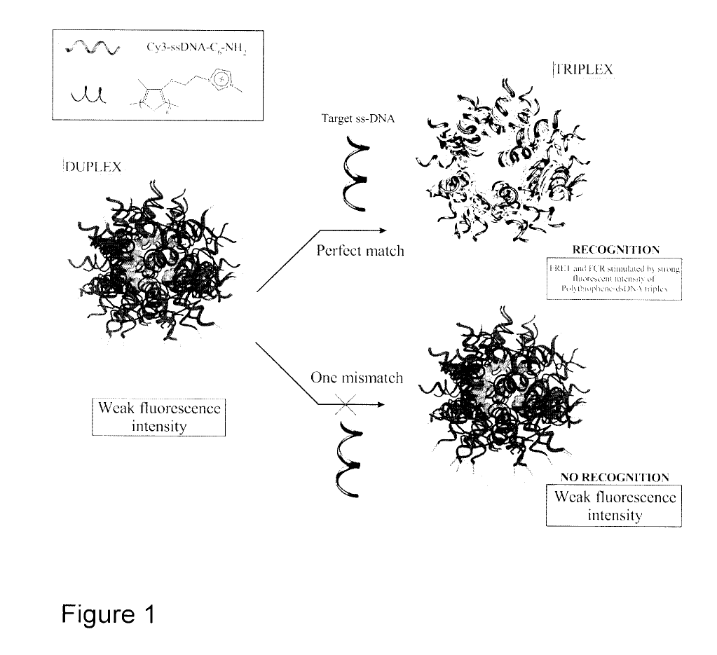

The cationic water-soluble polythiophene derivative (FIG. 1) which demonstrates advantageous properties has previously been described^{7,8}.

This polythiophene derivatives was used in the methods, assays, kits, articles, supports and arrays described herein and have the following formula;

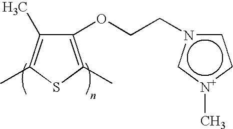

wherein n is an integer ranging from 6 to 100 (or any subranges, e.g., 6 to 75, 6 to 50, 10 to 55, 35 to 45, for example, n may be 40, 41, 42, 45 etc.).

Interestingly, this polymer was shown to exhibit different conformational structures and optical properties when put in the presence of free single-stranded (ss) nucleic acids or when complexed with target. More particularly, stoichiometric complexes of this polythiophene derivative and ss-DNA form nano-aggregates that result in a significant quenching of the fluorescence of the conjugated polymer. This polythiophene becomes fluorescent again through specific hybridization^{7,8} or DNA (aptamer)—protein interactions⁹.

The optical property of this polymer was further investigated in the development of a more rapid, simple, specific, reagentless and ultrasensitive solid-phase detection method.

Polythiophene derivatives were thus synthesized as previously described^{7,8}.

As it has recently been reported that a significant fluorescence signal amplification (fluorescence chain reaction or FCR)¹⁰ may take place with labeled ss-DNA probes, detection was performed with either labeled or unlabeled probes. The detection method with labeled ss-DNA probes is based on the efficient and fast energy transfer (Förster resonance energy transfer or FRET) between one resulting fluorescent polythiophene chain and many fluorophores attached to neighboring ss-DNA probes and may thus be useful in increasing the level of detection of the assay.

As such, in order to amplify the signal, a nucleic acid capture probe was labeled with a reporter molecule (a label). A suitable reporter may be chosen based on its absorption spectra which may be either identical to, similar to, or may overlap with the emission spectra of a cationic polythiophene derivative described herein. In accordance with the present invention, the reporter may be a chromophore and/or fluorophore. An exemplary embodiment of a reporter which is encompassed by the present invention is, without limitation, Cy3, Alexa Fluor 546 etc.

A single-stranded anionic (negatively charged) nucleic acid capture probe was mixed with a cationic polythiophene derivative and the complex was immobilized to the surface of a solid support. The anionic capture probe and the cationic polythiophene derivative may associate through electrostatic interactions and may thus form complexes such as duplexes and/or nano-aggregates on the surface of the support. The complex may preferably be stoichiometric.

The nucleic acid capture probe may be covalently attached to the support by means which are known in the art and which are not intended to be limitative. In an exemplary embodiment the probe may be attached through a linker moiety, either by its 3′-end or by its 5′-end.

The length of the nucleic acid capture probe may vary from about 12 to about 50 (or any subrange, e.g., 15 to 50, 20 to 45, etc.). Although other length may suitably be used without departing from the scope of the invention.

The capture probe may be selected, for example, from the group consisting of DNA, RNA and DNA/RNA chimera. The nucleic acid capture probe may comprise for example, standard nucleotide (unmodified) or modified nucleotides, where the modification are those which do not substantially affect the overall capacity of the probe to interact with the target and/or polythiophene derivative. Modified nucleotide may be those which, for example, do not substantially affect the overall negative charge of the probe. The nucleic acid capture probe may comprise a section (portion) that allows interaction with a desired target. This section of the nucleic acid probe may be selected to provide a specific interaction with the desired target while avoiding interaction with unspecific molecules. This section of the nucleic acid may also be selected to provide a reduced interaction with unoptimal targets. It is to be understood herein that the section of interaction between probe and target may cover the entire length of the probe and/or target.

The nucleic acid capture probe may thus comprise a section (portion) which is complementary to a desired (optimal) nucleic acid target. This section (or portion) of nucleic acid capture probe may also be substantially complementary to an unoptimal nucleic acid target.

The probe may also be designed to comprise an aptameric portion able to bind a protein or a small molecule of interest. Specific aptamers are known to bind various types of target such as vitamins (e.g., vitamin B12), ions (e.g., Zinc), chromophores (e.g. malachite green) coenzymes (e.g., coenzyme A), an amino acid derivative (e.g., dopamine), antibiotics (e.g., tobramycin), synthetic drugs (e.g., cocaine), etc.

A suitable target may thus be any molecule having an affinity for a specific sequence of nucleic acid.

Exemplary embodiments of suitable targets may be those selected from the group consisting of a nucleic acid molecule comprising a sequence complementary to a sequence of the capture probe (a target nucleic acid), a protein, protein complex or peptide (a target protein), an ion (a target ion), a vitamin, a chromophore, a coenzyme, an antibiotic a, synthetic drug, a small organic molecule (a target small molecule) and an amino acid or amino acid derivative (a target amino acid).

The target nucleic acid may be selected from the group consisting of DNA, RNA, and DNA/RNA chimeric molecules. The target nucleic acid may comprise, for example, standard nucleotide (unmodified) or modified nucleotides which do not substantially affect the overall capacity of the target to bind the probe and/or probe/polythiophene complex.

The target may be, for example, single-stranded, double-stranded or higher order (triplex, etc.). When the target is, for example, double-stranded, it may be denatured prior to being contacted with the probe/polythiophene derivative complex immobilized to the support.

The target nucleic acid may comprise a portion which is complementary to a portion of the nucleic acid capture probe. Also in accordance with the present invention, the target nucleic acid may also comprise a portion which is substantially complementary to a portion of the nucleic acid capture probe and may thus comprise at least one mismatch in this portion (e.g., a single nucleotide polymorphism) such as, at least one nucleotide mutation, at least one nucleotide insertion or at least one nucleotide deletion. It is to be understood that a target which comprise at least one mismatch relative to the capture probe, will generate either a lower or no signal in comparison to a target which comprises a portion 100% complementary to the capture probe. As such the lower signal (or absence of signal) may be interpreted as the absence of a target having a portion 100% complementary to the probe.

For example, when the capture probe has been designed to have a portion 100% complementary to the sequence of a wild type gene (a gene which is found in the majority of the population), the absence of a signal or a lower signal in the sample in comparison to a positive control upon carrying the method from a sample obtained from an individual as described herein may be interpreted as the individual carrying a gene different than the majority of the population.

In parallel, when the capture probe has been designed to have a portion 100% complementary to the sequence of a variant gene (a gene which is found in portion of the population and which may be associated with a disease or condition or else), the detection of a signal in a sample obtained from an individual may be interpreted as the individual carrying a variant gene associated with such disease or condition.

Of course an array may comprise both a probe designed to specifically bind a wild type gene and a probe or probes designed to recognize variant gene(s). Each of these probes are assigned a predetermined location on the array, which allow for the determination of the identity of the gene or gene product carried by the individual.

The target protein may also be a protein which specifically binds to the nucleic acid capture probe, whereas variants (e.g., genetic variant, mutants, etc.) of the protein may either bind to a lesser extent or may even not bind to the probe. The probe (i.e., nucleic acid sequence) and hybridization conditions may thus be selected to either avoid binding of sub-optimal target proteins or to allow binding of sub-optimal target proteins. For example, the methods and assays may be designed to allow detection and/or quantification of several protein variants or alternatively may be designed to allow detection and/or quantification of a single protein species.

The target may be in a substantially purified or isolated form or alternatively, in an unpurified form. The target may be found in a sample comprising other unspecific components or molecules such as, for example, a biological sample (e.g., blood, biopsies, etc. and extracts thereof).

The target may be of different source (e.g., cell lysate, blood, etc.), origin (e.g., mammalian, viral, bacterial, yeast, etc.) and form (e.g., linear, circular, etc.).

In order to carry out detection of the target, it is not necessary to carry out its labeling or its amplification (i.e., PCR amplification or else). As such, the target may be unlabeled and/or unamplified. However, PCR product may also be used if desired. Target concentration as low as 10⁻¹⁶M or 10⁻¹⁴M may efficiently be used to carry out the methods described herein.

As used herein the terms “single-stranded nucleic acid probe”, “single-stranded anionic nucleic acid capture probe”, “nucleic acid probe” or “capture probe” are used interchangeably.

As used herein the terms “desired target” or “optimal target” are used interchangeably and refer to a target which is sought to be detected and/or which has the capacity to bind to the nucleic acid capture probe described herein. For example, the terms “desired nucleic acid target” or “optimal nucleic acid target” refers to a nucleic acid molecule which is sought to be detected.

The terms “unoptimal target” or “sub-optimal targets” are used interchangeably and refer to a target which has a reduced capacity to bind or is incapable of binding to the nucleic acid capture probe described herein as compared to an optimal target.

As used herein the term “unspecific molecule(s)” refers to a molecule which does not significantly bind to a single-stranded negatively charged nucleic acid molecule capture probe described herein.

As used herein the term “complementary” with respect to nucleic acid molecules refers to a portion of the molecule that is able of base pairing with another nucleic acid molecule with a perfect (e.g., 100%) match. Base pairing is known in the art and may occur between modified or unmodified specific nucleotides through hydrogen bonds. As known in the art base pairing may occur between the base portion of a nucleotide, i.e., between adenine (A) and thymine (T), between adenine (A) and uracil (U), between guanine (G) and cytosine (C) or between inosine (I) and either one of uracil, adenine or cytosine.

As used herein the term “substantially complementary” with respect to nucleic acid molecules refers to a portion of the molecule that may be able of base-pairing with another nucleic acid molecule but which comprise at least one mismatch.

As used herein the term “mammal” refers the Mammalia class of higher vertebrates. The term “mammal” includes, but is not limited to, a human and an animal.

As used herein the term “species” in the context of nucleic acid probe refers to a probe having a predetermined sequence which is distinct than the sequence of another probe. For example, the term “a plurality of labeled single-stranded nucleic acid probe species” refers to at least two probe species and up to several thousands of probe species where each probe species has its own predetermined sequence and occupies a predetermined location on an array or support while another probe species has a different predetermined sequence and location.

The term “addressable” relates to the fact that the location and identity of each nucleic acid probe species on an array or support is predetermined and as such a signal detected at such location is attributed to the presence of a target capable of binding to the nucleic acid probe found at that specific location. The term “addressable” also means that each probe is positionally distinguishable.

The terms “polynucleotide,” “oligonucleotide,” and “nucleic acid” are used interchangeably herein to refer to a polymeric form of nucleotides of any length, and may comprise ribonucleotides, deoxyribonucleotides, analogs thereof, or mixtures thereof. More particularly, the terms “polynucleotide,” “oligonucleotide,” and “nucleic acid” include polydeoxyribonucleotides and polyribonucleotides, including tRNA, rRNA, hRNA, and mRNA, whether spliced or unspliced.

As used herein, the terms “nucleoside” and “nucleotide” will include those moieties which contain not only the known purine and pyrimidine bases, but also other heterocyclic bases which have been modified. Such modifications include methylated purines or pyrimidines, acylated purines or pyrimidines, or other heterocycles. Modified nucleosides or nucleotides can also include modifications on the sugar moiety, e.g., wherein one or more of the hydroxyl groups are replaced with halogen, aliphatic groups, or are functionalized as ethers, amines, or the like. Suitable modifications include those which do not alter the electrostatic interaction of the probe with the polythiophene derivative and those which do not affect binding to the target (e.g. base-pairing with the target).

The sample comprising or suspected of comprising the target may be of any source of material, originating or isolated for example, from plants, mammals, insects, amphibians, fish, crustaceans, reptiles, birds, bacteria, viruses, archaeans, food, etc. or from an inorganic sample onto which a target has been deposited or extracted (forensic, objects, rocks, etc.). Biological material may be obtained from an organism directly or indirectly, including cells, tissue or fluid, and the deposits left by that organism, including viruses, mycoplasma, and fossils. The sample may comprise a target prepared through synthetic means, in whole or in part. Nonlimiting examples of the sample may include blood, urine, semen, mil k, sputum, mucus, a buccal swab, a vaginal swab, a rectal swab, an aspirate, a needle biopsy, a section of tissue obtained for example by surgery or autopsy, plasma, serum, spinal fluid, lymph fluid, the external secretions of the skin, respiratory, intestinal, and genitourinary tracts, tears, saliva, tumors, organs, samples of in vitro cell culture constituents (including but not limited to conditioned medium resulting from the growth of cells in cell culture medium, putatively virally infected cells, recombinant cells, and cell components), and a recombinant library comprising polynucleotide sequences.

The sample may be diluted, dissolved, suspended, extracted or otherwise treated to solubilize and/or purify any putative target present or to render it accessible to reagents which are used in an amplification scheme or to detection reagents. Where the sample contains cells, the cells may be lysed or permeabilized to release the target from within the cells.

The target may be a polynucleotide which may be in a single-stranded, double-stranded, or higher order, and can be linear or circular. Exemplary single-stranded target polynucleotides include mRNA, rRNA, tRNA, hnRNA, ssRNA or ssDNA viral genomes, although these polynucleotides may contain internally complementary sequences and significant secondary structure. Exemplary double-stranded target polynucleotides include genomic DNA, mitochondrial DNA, chloroplast DNA, dsRNA or dsDNA viral genomes, plasmids, phage, and viroids. The target polynucleotide can be prepared synthetically or purified from a biological source. The target polynucleotide may be purified to remove or diminish one or more undesired components of the sample or to concentrate the target polynucleotide.

The target may be a protein or any other molecule which is capable of specific binding to a nucleic acid sequence. Exemplary embodiments of protein includes for example and without limitation, transcription factors, RNA or DNA Polymerase, ligases, integrase, recombinase etc. Alternatively, nucleic acid library may be screened using a desired protein or molecule of interest to select a specific sequence which in turn may be used for generating detection tools for identifying, quantifying, isolating the desired protein or molecule from a sample using the present invention.

### Materials

Several attempts to generate a stable and useful Biochip were found unsuccessful. For example, when the polythiophene derivative was covalently linked to the solid support or when the chromophore or fluorophore was linked to the polythiophene derivative the assay was found to be non-functional. However, when we chose to link the capture probe to the support instead of the polythiophene derivative, the assay was found to be of high sensitivity and specificity. Thus the addition of a linker at the 5′-end of the capture probe for attachment to the support and the addition of a label at the 3′-end does not appear to affect the efficiency of the probe, i.e., the probe is flexible enough and is still capable of specific binding to the target. Alternatively, the addition of a linker at the 3′-end of the capture probe for attachment to the support and the addition of a label at the 5′-end is also encompassed by the present invention.

All chemicals were purchased from Sigma and used without further purification. Labeled and unlabeled oligonucleotides were purchased from Integrated DNA Technologies, Inc. Seven oligonucleotides were utilized. As exemplary embodiments of the invention, two capture probes (labeled or unlabeled) were used for DNA detection, 5′-NH₂—C₆-CAT GAT TGA ACC ATC CAC CA-Cy3-3′ (P₁) and 5′-NH₂—C₆-CAT GAT TGA ACC ATC CAC CA-3′ (P₂) and two targets, one perfect complementary, 3′-GTA CTA ACT TGG TAG GTG GT-5′ (T₁), which corresponds to a conserve region of the Candida albicans yeast genome, and one sequence having one mismatched base, 3′-GTA CTA ACT TCG TAG GTG GT-5′ (T₂). In the case of proteins detection, three capture, probes were used, 5′-NH₂—C₆-GGT TGG TGT GGT TGG-Cy3-3′ (P₃: specific sequence), 5′-NH₂—C₆-GGT TGG TGT GGT TGG-3′ (P₄: specific sequence) and 5′-NH₂—C₆-GGT GGT GGT TGT GGT-Cy3-3′ (P₅: non-specific sequence). The amino-linker (Amino group connect to an aliphatic chain of six carbons) modification allowed covalent attachment of probes onto functionalized glass surfaces. Although it was decided to use a linker of six carbon atoms, linkers having a length of from 2 to 30 atoms of different natures (i.e. C, PolyEthylene oxyde (PEO) . . . ) may also be used. It would also be possible to in this case to plan a linker much longer. Therefore the nature of the linker is in no way to be interpreted as limiting the invention. Human α-thrombin was purchased from Haematologic Technologies Inc. BSA (Bovine Serum Albumin) was obtained from Sigma and IgE from USBiological.

### Preparation of Glass Slides

Glass slides were used as exemplary embodiments of solid support. Microscope glass slides (25×75×1 mm) were obtained from Fisherbrand. After successive sonications (5 min) in chloroform, acetone, and isopropyl alcohol followed by rinsing with sterilized water, precleaned microscope slides were sonicated 15 min in pyrhana solution (⅔H₂SO₄+⅓H₂O₂). The slides were then rinsed abundantly with sterilized water. They were then sonicated for 1 h in a 2.5 M aqueous solution of NaOH followed by rinsing with sterilized water. The slides were sonicated in an aminopropyltrimethoxysilane solution (90 mL of isopropanol, 10 mL of water, 0.5 mL of aminopropyltrimethoxysilane) for 15 min rinsed with isopropanol, dried and baked for 15 min at 110° C. The amine-modified slides were activated by one hour sonication in 40 mL dioxane containing 0.32 g of carbonyldiimidazole, washed successively with dioxane and diethyl ether, and dried under a stream of nitrogen.

Although a glass slide was used in one of the exemplary embodiment of the invention, the support may be made of other material such as for example, plastic, ceramic, metal (e.g., gold), resin, gel, glass, silicon, polymeric substrates or composites. The solid support may also be for example, a disc, a microchip, a well of a microtiter plate, a membrane, etc. Immobilization of probes onto a solid support may be effected by means which are known in the art and which are not intended to be limitative. The solid support may also be non-conductive.

The solid support may be chosen to comprise at least one complex formed by a single-stranded anionic nucleic acid having affinity for a desired target and the cationic polythiophene derivative described herein.

### Arrays Production

In case of the DNA detection, probes were diluted into water to a final concentration of 5 μM and mixed stoichiometrically (on a repeat unit basis) with the cationic water-soluble polythiophene (74 μM order to form the duplex. In case of the protein detection, 2.9×10⁻⁹ mol of polymer (based on charge repeat unit) and 2.9×10⁻⁹ mol (based on monomeric unit or 1.9×10⁻¹⁰ mol of 15-mer) of ss-DNA thrombin aptamer were mixed at 25° C. Then, mixture solution is sonicated for 20 min at 37° C., before arrays are produced by spotting the mixture onto functionalized glass slide. Spot had a volume of 0.4 μL, a diameter between 1500 and 1700 μm and contained about 1.2×10¹² amino-modified probes. After spotting, the duplexes are dried at room temperature (22° C.) for 15 min and then, washed by 0.1% Igepal CA-630 (Sigma-Aldrich) for 1 min and rinsed in ultra-pure water for 1 min, and dried under a steam of argon. After duplex immobilization, the array may be used immediately or stored under dry, dark conditions at room temperature. It was found that the preparation of the arrays was best performed by mixing the labeled capture probes and polythiophene derivative prior to the attachment of the complex to the support. Attempts at doing otherwise were unsuccessful. It was also surprisingly found that drying the support once the complex has been spotted did not affect the assay. The arrays may thus be provided to the user in a dry form. This is particularly useful for the packaging, storing and distribution aspect of kits comprising such arrays.

Hybridization may be performed under various stringency conditions in order to control the interaction between the probe and the target.

By using low or medium stringency conditions, the nucleic acid capture probe may bind more efficiently to unoptimal targets which depending on the goal of the assay may be desirable. Upon increasing the stringency conditions, the binding of unoptimal targets and unspecific molecules to the nucleic acid capture probe may be decreased. For example, the methods and assays may be designed to allow detection and/or quantification of several nucleic acid homologs or alternatively may be designed to allow detection and/or quantification of a single nucleic acid species.

Target hybridization was thus performed by using unlabeled target DNA in NaCl solution (0.1 M), which concentrations ranged from 1 μM to 0.1 fM in case of sensitivity experiments. After hybridization, the slides were carried out at 37° C. inside a humid chamber for 1 hour. Concerning protein detection, 0.4 μL (1.9×10⁻¹⁰ mol, the initial concentrated solution of thrombin was diluted with sterilized water to obtain the appropriate concentration) of human α-thrombin and was then spotted on the previous spot of duplex. After the incubation period (one hour for target DNA and 30 min for target protein), the slides were washed with 0.1% Igepal for 1 min, rinsed in ultra-pure water for 1 min and dried under a stream of argon.

Methods of detecting, quantifying or determining the presence of a target in a sample may thus be performed by contacting a support, article or array (to which a probe able to bind to the target sought to be detected has been immobilized and complexed with a polythiophene derivative) and a sample which comprises the target or is suspected of comprising the target.

Methods of the present invention may further comprise providing suitable conditions for generating a detectable or measurable signal. For example, a suitable excitation wavelength may be provided and the emission of fluorescence, a change in the fluorescence intensity and/or appearance of a color may be measured. The detection of the signal may be conducted with appropriate means and apparatus which are know in the art and which may include for example, an optical means (e.g., spectrophotomer, etc.), an electrochemical detector, and a fluorescence detector (e.g., fluorescence scanner, epifluorescence microscope, etc.).

The method may further comprise comparing the signal or measurement obtained for the sample with the signal obtained for a positive and/or negative sample. The absence of a signal may be indicative of an absence of a desired target in a sample, whereas the presence or increase of a signal may be indicative of the presence of a desired target in a sample.

More particularly, it is to be understood herein that the presence or absence of a desired target may be indicative of a disease, disorder or condition (e.g., an infection with a microorganism) or alternatively may be indicative of an increased or decreased risk of developing a particular disease, disorder or condition, or again may provide indication as to the proper therapy to be administered to an individual in need thereof. These embodiments represent only examples of the utility of supports, kits, arrays, reagents, assays and methods described herein.

### Fluorescence Measurements

Although other apparatus and devices may be used, all fluorescence measurements were performed with a custom-modified microarray fluorescence scanner from Packard Bioscience Biochip Technologies (model ScanArray 5000 XL). The excitation wavelength of 408 nm, which overlaps well with the absorption spectral profile of the polymer transducer, was provided through the integration of a blue-violet laser diode (Power Technologies, model IQ1A50-LD1539-G26) into the scanner. The interference emission filters of 570 nm (emission wavelength of Cy3) and 530 nm were selected through the control software of the instrument. Fluorescent signals of different spots were analyzed using ScanArray Express software (PerkinElmer. inc.). Each test was carried out three times on the same chip. For each concentration, the mean integrated fluorescence intensity and associated standard deviation were calculated. Picture treatment of spots was carried out using the Corel photo software where ⅔ of the initial spots were cut out and placed on a black sheet and then analyzed.

### Atomic Force Microscopy (AFM)

Functionalized glass slide (1×1 cm) modified with duplex was imaged by Digital Instruments Nanoscope IIIa scanning probe microscope in tapping mode. AFM images were captured with Nan scope Ixia software version 5.12r5. The images were captured at 10 and 1 mm size respectively with a height scale of 20 nm and 30 nm.

### EXAMPLES

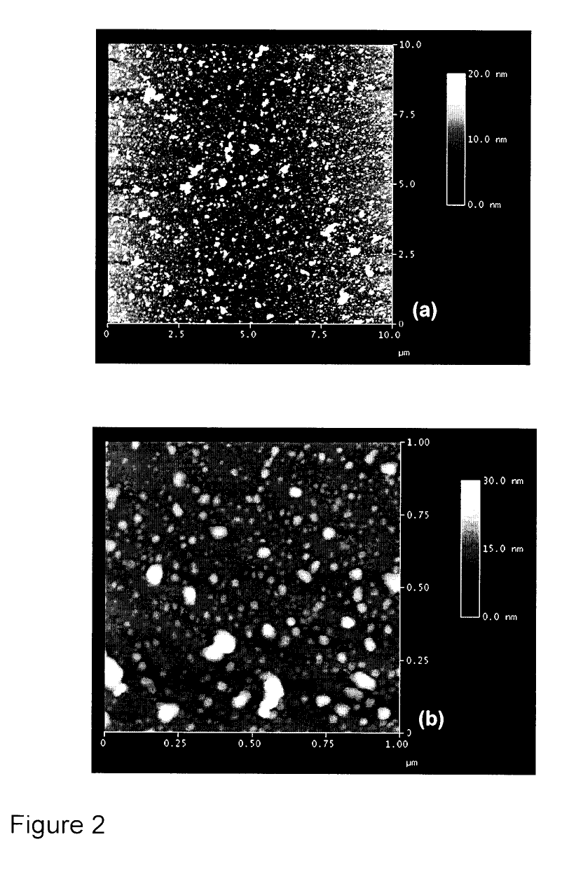

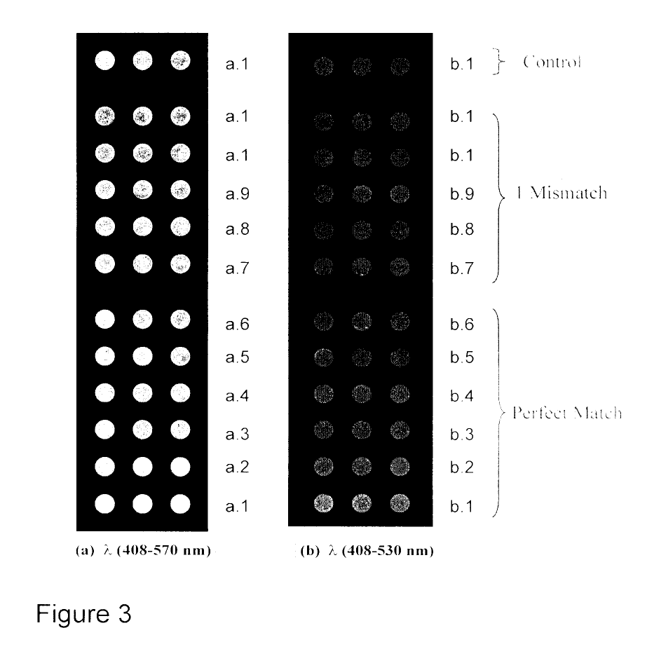

Stoichiometric complexes (duplexes) were thus prepared by mixing the polythiophene optical transducer with a Cy3-labeled ss-DNA capture probe. As indicated herein, this exemplary chromophore has been chosen because its absorption spectrum overlaps well with the emission spectrum of the polythiophene, allowing efficient FRET mechanism. However, to permit the covalent binding of these aggregates onto glass slides, an amine group was also inserted at the 5′-end of the ss-DNA capture probes. Upon spotting (see methods section), nano-aggregates (probably micelles) made of hybrid polythiophene/ssDNA (5′-NH₂—C₆-CAT GAT TGA ACC ATC CAC CA-Cy3-3′) complexes were therefore bound onto the glass surface (FIGS. 1 and 2). The average aggregate diameter of the spot was around 200-250 nm, while the height was around 20 to 30 nm. The diameter of the spots was about 1.5-1.7 mm (see FIG. 3), and included about 1×10¹² probes per spot.

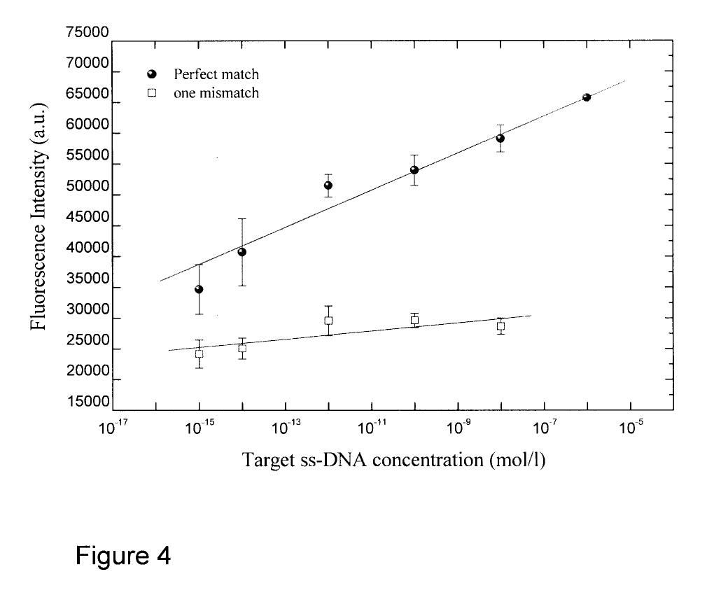

Glass slides were scanned using an excitation wavelength at 408 nm, which fits well with the absorption spectrum of the polymeric optical transducer. The emission was recorded at 570 nm, which corresponds to the maximum of emission of the Cy3 fluorophore (FIG. 3a). As a control of the efficiency of the FRET mechanism, emission was also detected at 530 nm, wavelength of the maximum of emission of the polythiophene derivative (FIG. 3b). FIG. 3 shows the fluorescence intensity of the duplex after hybridization (formation of triplex) by perfect complementary target (3′-GTA CTA ACT TGG TAG GTG GT-5′) oligonucleotides (a-1 to a-6 and b-1 to b-6) and a target having 1 mismatch (3′-GTA CTA ACT TCG TAG GTG GT-5′) (a-7 to a-11 and b-7 to b-11). Concentrations range from 1×10⁻⁶ M to 1×10⁻¹⁵ M. As was found from solution measurements¹⁰, fluorescence is quenched in the starting duplexes and only turns on upon specific hybridization. Fluorescence intensity shows a clear contrast between perfect complementary targets and those having one mismatch (FIGS. 3a and 4). Fluorescence intensities are logarithmically related to the target concentrations. Interestingly, fluorescence intensity coming from the hybridization of a perfect complementary target at a concentration of about 1×10⁻¹⁴ M is well above that obtained with a target having one mismatch at a concentration of 1×10⁻⁸ M, implying a remarkable selectivity of the detection. Moreover, as shown in FIG. 3b, the fluorescence intensity at 530 nm is very weak, either for a perfect complementary or 1 mismatch target. This observation indicates that the FRET mechanism is highly efficient.

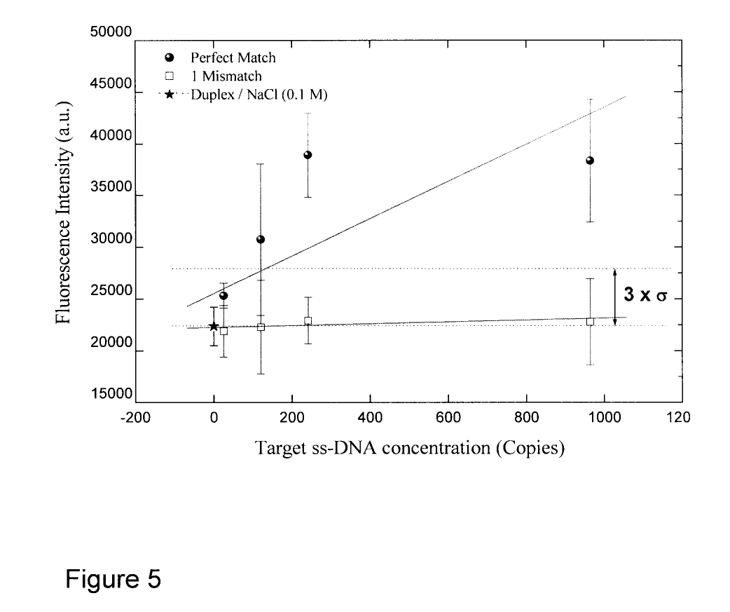

Analyses at very low concentrations (see FIG. 5) enabled the determination of a limit of detection (LOD) of around 5.4×10⁻¹⁶ M for a perfect complementary target oligonucleotides in a volume of 400 nL (corresponding to ca. 300 copies). The comparison of the limit of detection of an unlabeled duplex (5′-NH₂—C₆-CAT GAT TGA ACC ATC CAC CA-3′+cationic polymer) (experiments not showed) with the above-described system indicates a lower sensitivity by a factor of around 1500. This implies that in addition to the FRET phenomenon, these matrixes induce a significant amplification of the detection due to the Fluorescence Chain Reaction (FCR) mechanism.

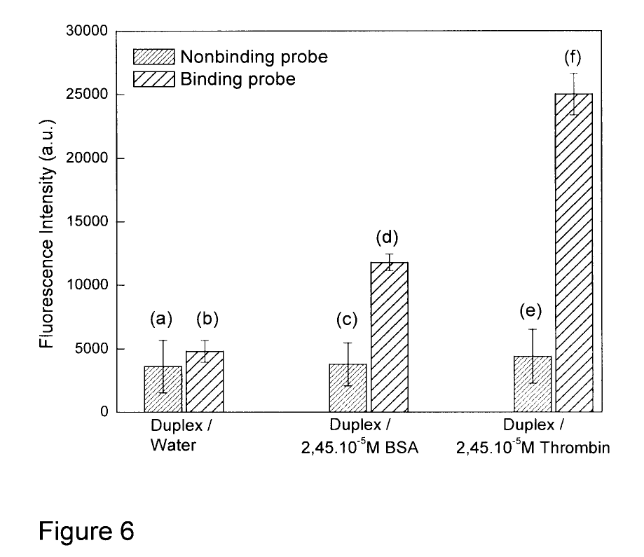

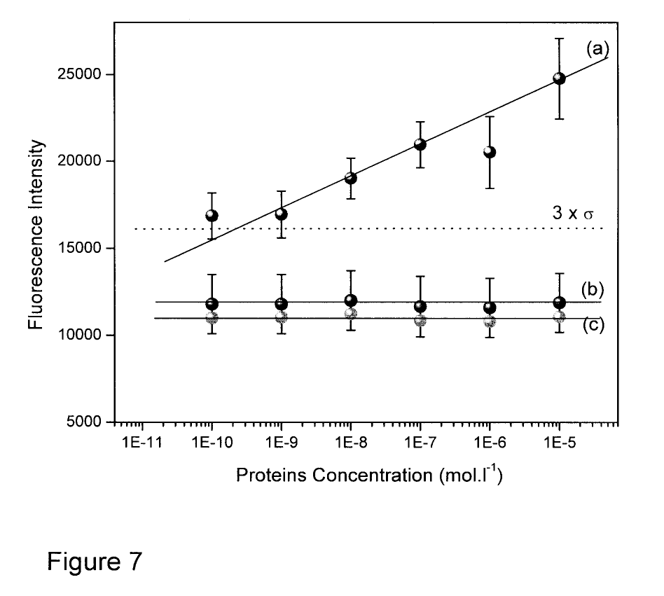

Due to their central importance in many biological processes, there is also a high demand for convenient methodologies for detecting specific proteins in biological samples. Recently, aptamer based sensors as new protein recognition elements have received considerable attention¹¹⁻¹³. As mentioned above, we previously reported the design of optical sensors based on hybrid aptamer/polythiophene complexes in aqueous solutions⁹. The DNA aptamer bound to a specific protein undergoes a conformational transition from an unfolded to a folded (G-quartet) structure which may be detected by the cationic polythiophene derivative. Therefore, on the basis of our polymeric DNA-chips, we designed the following strategy: first, P₃ (5′-NH₂—C₆-GGT TGG TGT GGT TGG-Cy3-3′), P₄ (5′-NH₂—C₆-GGT TGG TGT GGT TGG-3′) and P₅ (5′-NH₂—C₆-GGT GGT GGT TGT GGT-Cy3-3′) were put in presence of cationic polythiophene in order to form stoichiometric duplexes. P₃ and P₄ are both specific sequences of thrombin⁹, however P₃ is labeled with Cy3 fluorophore while P₄ is not. FIGS. 6 and 7 show the results from these labeled DNA sequences and different protein targets. One may observe that in presence of the thrombin, the spots having the hybrid labeled aptamer P₃/polythiophene complexes show a significant increase of the fluorescence which tends to be proportional to the logarithm of the concentration of the thrombin. These experiments reveal a limit of detection of 2×10⁻¹⁰ M in 0.4 μL (i.e. 4.8×10⁷ molecules of thrombin). The amplification of the detection through the FCR scheme was verified by the use of a non labeled probe in the same conditions (results not shown). The sensitivity is about 1000 times inferior in the case of unlabeled probes when compared to labeled probes. These results support our previous results on DNA where the amplification of the detection was also assumed not only be related to a FRET mechanism but also to a phenomenon called Fluorescence Chain Reaction (FCR).

Three control experiments were done to verify the specificity of the detection. Two proteins, BSA (Bovine Serum Albumin) and IgE were used in the same conditions and fluorescence intensities remained quite low (see FIGS. 6 and 7). This reveals an excellent specificity of the detection with respect to the target. In the third case, the use of a nonbinding sequence (P₅) for human thrombin confirms also the specificity of the detection with respect to the probe. Indeed, as shown in FIG. 6, despite the presence of Cy3 fluorophore on the probe, only a weak emission of fluorescence in the presence (or the absence) of thrombin was observed. Once again, it is interesting to note that thrombin may be specifically detected even in the presence of a large excess (10⁶ fold) of other non-binding proteins.

These studies have allowed the development of responsive polymeric biochips which may directly and specifically detect DNA and proteins. It has been shown that as few as 300 DNA molecules may be detected, even in the presence of a large excess of one-mismatched DNA molecules. Moreover, by combining the right DNA aptamer with the polythiophene optical transducer, human thrombin may be specifically detected within 30 min, without any tagging of the target. Finally, by using smaller spots and microfluidic hybridization devices, faster and more sensitive detections may be developed¹⁴.

Preparation of arrays for the detection of multiple targets is also encompassed by the present invention.

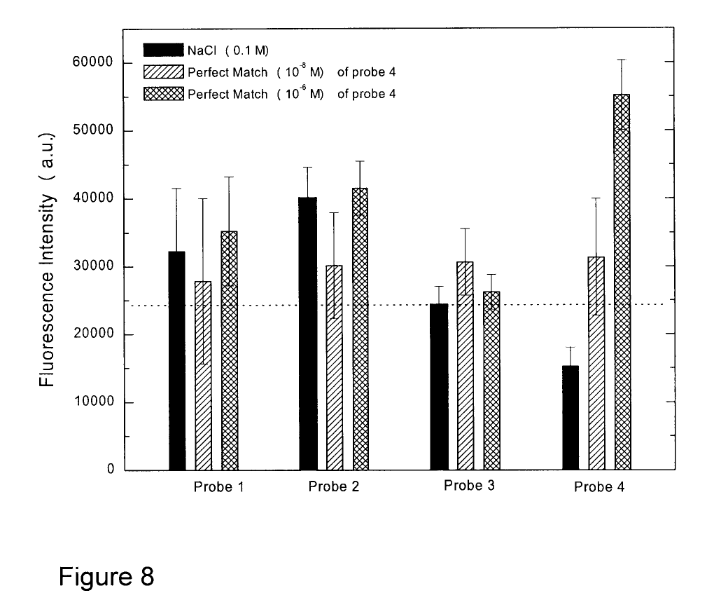

For example, results of FIG. 8, illustrates hybridization between the probe 4 and his perfect complementary target at 10⁻⁶ M and 10⁻⁸ M. An increase of the fluorescence intensity at both concentration of target compared to the reference (Duplex/NaCl 0.1M) is observed. In this case the duplex corresponds to mix of cationic polythiophene and the probe 4. Concerning the fluorescence intensity of this other probes, in the same hybridization conditions, hybridization (binding) with target at 10⁻⁶ M and 10⁻⁸ M doesn't occur as no variation of the fluorescence intensity is noted.

Specific binding of target to the capture probe results in a detectable change at each specific location on the biochip. The detectable change can include, but is not limited to, a change in fluorescence, or a change in a physical parameter, such as electrical conductance or refractive index, at each location on the biochip.

The biochip will then be read by a device, such as a fluorescence scanner or a surface plasmon resonance detector, that can measure the magnitude of the change at each location on the biochip. The location of the change reveals what target molecule has been detected, and the magnitude of the change indicates how much of it is present. The combination of these two pieces of information will yield diagnostic and prognostic medical information when signal patterns are compared with those obtained from bodily fluids of individuals with diagnosed disorders. In principle, the biochip could be used to test any chemically complex mixture provided that the capture probe capable of binding to a target suspected of being present in the mixture are attached to the biochip.

Although the present invention has been described hereinabove by way of exemplary embodiments, it can be modified without departing from the spirit, scope and the nature of the invention.

### REFERENCES

1 Fodor, S. P. A. et al. Light-directed, spatially addressable parallel chemical synthesis. Science 251, 767-773 (1991)
2 Heller, M. J. DNA microarray technology: devices, systems, and applications. Annu. Rev. Biomed. Eng. 4, 129-153 (2002).
3 Taton, T. A., Mirkin, C. A. & Letsinger, R. L. Scanometric DNA array detection with nanoparticle probes. Science 289, 1757-1760 (2000).
4 Nilsson, K. P. R. & Inganäs, O., Chip and solution detection of DNA hybridization using a luminescent zwitterionic polythiophene derivative. Nat. Mater. 2, 419-424 (2003).
5 Liu, R. H., Yang, J., Lenigk, R., Bonanno, J. & Grodzinski, P. Self-contained, fully integrated biochip for sample preparation, polymerase chain reaction amplification, and DNA microarray detection. Anal. Chem. 76, 1824-1831 (2004).
6 Saiki, R. K et al. Enzymatic amplification of beta-globin genomic sequences and restriction site analysis from diagnosis of sickle-cell anemia. Science 230, 1350-1354 (1985).
7 Ho, H. A. et al. Colorimetric and fluorometric detection of nucleic acids using cationic polythiophene derivatives. Angew. Chem. Int. Ed. 41, 1548-1551 (2002).
8 Doré, K. et al. Fluorescent polymeric transducer for the rapid, simple and specific detection of nucleic acids at the zeptomole level. J. Am. Chem. Soc. 126, 4240 (2004).
9 Ho, H. A. & Leclerc, M. Optical sensors based on hybrid aptamer/conjugated polymer complexes. J. Am. Chem. Soc. 126, 1384-1387 (2004).
10 Ho, H. A. et al. Direct molecular detection of nucleic acid by fluorescence signal amplification. J. Am. Chem. Soc. 127, 12673-12676 (2005).
11 Robertson, D. L. & Joyce, G. F. Selection in vitro of an RNA enzyme that specifically cleaves single-stranded DNA. Nature 344, 467-468 (1990).
12 Ellington, A. D. & Szostak, J. W. In vitro selection of RNA molecules that bind specific ligands. Nature 346, 818-822 (1990).
13 Tuerk, C. & Gold, L. Systematic evolution of ligands by exponential enrichment—RNA ligands to bacteriophage-T4 DNA-polymerase. Science 249, 505-510 (1990).
14 Peytavi, R. et al., Microfluidic device for rapid (<15 min) automated microarray hybridization, Clin. Chem. 51, 1836-1844 (2005).

1. An article of manufacturing comprising a solid support onto which is attached a complex formed by a labeled single-stranded nucleic acid probe and a polythiophene derivative of formula I 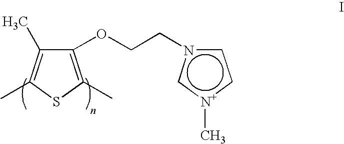
wherein n is an integer ranging from 6 to 100; and
wherein the labeled single-stranded nucleic acid probe is covalently attached to a surface of the solid support and the polytiophene derivative is in electrostatic interaction with the labeled single-stranded nucleic acid probe.

2. The article of manufacturing of claim 1, wherein the labeled single-stranded nucleic acid probe comprise a linker moiety at a first end thereof and is attached to the solid support by the linker moiety.

3. The article of manufacturing of claim 1, wherein the labeled single-stranded nucleic acid probe comprise a label at a second end thereof.

4. The article of manufacturing of claim 1, wherein the labeled single-stranded nucleic acid probe comprise a fluorophore.

5. The article of manufacturing of claim 1, wherein the labeled single-stranded nucleic acid probe comprise a chromophore.

6. The article of manufacturing of claim 1, wherein the labeled single-stranded nucleic acid probe and polythiophene derivative are in stoichiometric amount.

7. The article of manufacturing of claim 1, wherein the article is provided in a dried form.

8. An array comprising a plurality of labeled single-stranded nucleic acid probe species covalently attached to a different predetermined region of a solid support surface and a polytiophene derivative in electrostatic interaction with each of the labeled single-stranded nucleic acid probe species, the polythiophene derivative having formula I 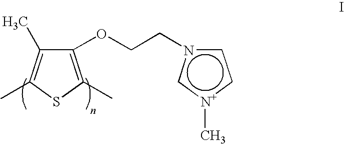
wherein n is an integer ranging from 6 to 100.

9. The array of claim 8, wherein each of the labeled single-stranded nucleic acid probe species is capable of binding a different target.

10. A method for the detection of a target, the method comprising:
contacting a sample comprising the target or susceptible of comprising the target with a complex formed by a labeled single-stranded nucleic acid probe attached to a solid support and a polythiophene derivative of formula I 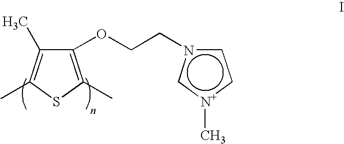
wherein n is an integer ranging from 6 to 100; and
measuring a signal emitted upon specific binding between the single-stranded nucleic acid probe and the target.

11. The method of claim 10, wherein the single-stranded nucleic acid probe is labeled with a fluorophore.

12. The method of claim 10, wherein the single-stranded nucleic acid probe is labeled with a chromophore.

13. The method of claim 10, wherein the single-stranded nucleic acid probe is covalently linked to the solid support.

14. The method of claim 10, wherein the target is unlabeled.

15. The method of claim 10, wherein the target comprises a nucleic acid.

16. The method of claim 15, wherein the nucleic acid is single-stranded or double-stranded.

17. The method of claim 15, wherein the nucleic acid comprises DNA or RNA.

18. The method of claim 15, wherein the nucleic acid comprises a portion complementary to a portion of the single-stranded nucleic acid probe.

19. The method of claim 10, wherein the single-stranded nucleic acid probe comprises a sequence associated with genetic polymorphism among a population of mammals or microorganism.

20. The method of claim 10, wherein the signal is an emission of light in the visible range.

21. The method of claim 10, wherein the signal is a change of color in the visible spectra.

22. The method of claim 10, wherein the target is an ion, a vitamin, a chromophore, a coenzyme, an antibiotic, a synthetic drug, an amino acid or amino acid derivative.

23. The method of claim 10, wherein the target comprises a protein, a protein complex or a peptide.

24. A system for the detection of a target, the system comprising a complex made of
a single-stranded nucleic acid probe comprising a fluorophore and a linker and;
a polythiophene derivative of formula I 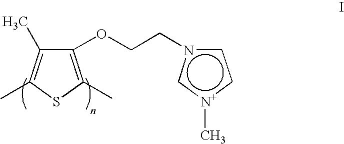
wherein n is an integer ranging from 6 to 100 and;
wherein the single-stranded nucleic acid probe is covalently linked to a solid support through said linker.

25. The system of claim 24, wherein the complex is a stoichiometric complex.

26. The system of claim 24, wherein the target is capable of specific binding to the single-stranded nucleic acid probe.

27. The system of claim 24, wherein the single-stranded nucleic acid probe comprises a portion complementary to a target nucleic acid sequence.

28. The system of claim 24, wherein the single-stranded nucleic acid probe comprises an aptameric portion for binding a molecule selected from the group consisting of a protein, a protein complex, a peptide, an ion, a vitamin, a chromophore, a coenzyme, an antibiotic, a synthetic drug, a small organic molecule, an amino acid and an amino acid derivative thereof.

29. A method of making a detection kit, the method comprising mixing a single-stranded nucleic acid probe comprising an attaching means and a cationic polythiophene derivative under condition allowing for their electrostatic interaction, and immobilizing the complex onto the surface of a responsive solid support.

30. The detection kit made by the method of claim 29.

31. A detection kit comprising
a vial or vials containing a single-stranded nucleic acid probe comprising a linker for attachment to a solid support; and
a vial or vials containing a polythiophene derivative of formula I 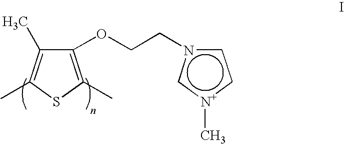
wherein n is an integer ranging from 6 to 100.

32. The detection kit of claim 31, further comprising a solid support.

33. The detection kit of claim 32, wherein the solid support is receptive to the linker of the single-stranded nucleic acid probe.

34. The detection kit of claim 31, further comprising instructions for attachment of the single-stranded nucleic acid probe to a solid support.

35. A method of making an array, the method comprising
separately providing a plurality of single-stranded nucleic acid probe species each comprising an attaching means;
separately mixing each of the single-stranded nucleic acid probe species with a cationic polythiophene derivative under condition allowing for their electrostatic interaction thereby separately forming a plurality of distinguishable complexes, and
immobilizing each of the distinguishable complexes onto the surface of a different predetermined region of the solid support.

36. The array made by the method of claim 35.

37. A method for the diagnosis of a disease, disorder or condition in a mammal, the method comprising
providing a sample comprising a target or suspected of comprising a target associated with said disease, disorder or condition and obtained from said mammal; and;
contacting the sample with a solid support including a complex formed by a labeled single-stranded nucleic acid probe attached thereto and a polythiophene derivative, wherein said labeled single-stranded nucleic acid probe comprises a nucleic acid sequence capable of specific binding to the target.

38. An array comprising a solid support and a plurality of positionally distinguishable labeled single-stranded nucleic acid probes attached to the solid support and complexed with a polythiophene derivative of formula I 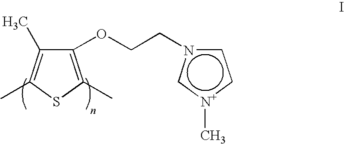
wherein n is an integer ranging from 6 to 100.

39. The array of claim 38, wherein the labeled single-stranded nucleic acid probe comprises a fluorophore or a chromophore.

40. The array of claim 38 wherein each of the labeled single-stranded nucleic acid probes comprises at least 12 nucleotides and has a predetermined different nucleotide sequence.

41. The array of claim 38, wherein each of the labeled single-stranded nucleic acid probes is composed of DNA, RNA or a combination thereof.
